(19) United States
(12) Patent Application Publication
(10) Pub. No.: US 2025/0205842 A1
(43) Pub. Date: Jun. 26, 2025

(54) COOLANT SUPPLY APPARATUS

(71) Applicant: DMG MORI CO., LTD., Nara (JP)

(72) Inventor: Genki FUNAKOSHI, Nara (JP)

(73) Assignee: DMG MORI CO., LTD., Nara (JP)

(21) Appl. No.: 18/959,028

(22) Filed: Nov. 25, 2024

(30) Foreign Application Priority Data
Dec. 26, 2023 (JP) 2023-219547

(51) Int. Cl. B23Q 11/12; B23Q 11/00; B23Q 11/10

(52) U.S. Cl. CPC B23Q 11/126; B23Q 11/0075; B23Q 11/1069

(57) ABSTRACT

[Problem] To separate dispersed oil in a coolant and reduce the clogging of a filter.

[Means of Solution] Provided is a coolant supply apparatus including: a coolant tank configured to store (i) a first coolant C1 supplied to a machine tool and (ii) (a) machining debris and (b) dispersed oil dispersed from the first coolant that flow with the first coolant from a place supplied; a debris separation section configured to separate the machining debris from a second coolant C2 collected from a coolant stored in the coolant tank; and a hydrophilic oil-repellent filter configured to separate the dispersed oil from a third coolant C3 separation-treated in the debris separation section.

### TECHNICAL FIELD

The present invention relates to a coolant supply apparatus.

### BACKGROUND ART

As an apparatus attached to a machine tool, a coolant supply apparatus that supplies a water-soluble coolant to the machining area of the machine tool has been known. The coolant supplied from the coolant supply apparatus cools tool cutting edges and workpieces, and discharges machining debris generated by machining to the outside of the machining area.

Since a machine tool has movable mechanisms, a lubricant is supplied to a machine tool. Thus, the coolant supplied to the machining area is collected with such a lubricant mixed therein into a coolant tank. When a workpiece is machined, machining debris is generated. Thus, the coolant is collected with machining debris mixed therein into the coolant tank. The performance of the coolant is likely to be low when the coolant is mixed with a lubricant and machining debris. Furthermore, an oil film is formed on the surface layer of the coolant in the tank, which often causes anaerobic bacteria to grow and produce putrid odors.

To handle such a problem, for example, Patent Literature 1 discloses the following coolant supply apparatus. That is, this coolant supply apparatus includes a storage tank that stores a coolant used in a machine tool and a nozzle that suctions from the storage tank the coolant that contains machining debris and contains oil dispersed on the liquid surface thereof. The coolant supply apparatus further includes a sludge separation dehydrator that collects machining debris and the like from the coolant suctioned by the nozzle and a coarsening element that separates the oil from the coolant after the debris removal. The sludge separation dehydrator includes a bag-shaped filter. The bag-shaped filter is composed of a nonwoven fabric, in which fibers are dispersed randomly, or the like. The bag-shaped filter filtrates the coolant passing through the filter to separate the machining debris from the coolant. The coarsening element is composed of an ultrafine fiber sheet, such as a nonwoven fabric. The coarsening element captures, agglomerates, coarsens, and separates the oil in the coolant passing through the coarsening element. The coolant that passed through the coarsening element is returned to the storage tank and supplied again to the machine tool.

### CITATION LIST

### Patent Literature

[Patent Literature 1] JP 9-201502 A

### SUMMARY OF INVENTION

### Technical Problem

One method for purifying a coolant containing machining debris and oil includes filtrating the coolant with a filter. However, when both machining debris and oil are filtrated, the filter is likely to be clogged with machining debris. Thus, the life of the filter life tends to be shortened, and the filter tends to need replacing more often. In contrast, the coolant supply apparatus of Patent Literature 1 first separates machining debris and then separates oil. This extends the life of the filter that separates the oil.

By the way, examples of oil contained in a coolant include floating oil floating on the coolant liquid surface and dispersed oil dispersed in the coolant liquid. Floating oil normally has a size of 200 μm or larger. Dispersed oil normally has a size of 2 to 10 μm. Therefore, separation of dispersed oil is more difficult than separation of floating oil.

In the coolant supply apparatus of Patent Literature 1, dispersed oil is separated in the coarsening element. The coolant passing through the coarsening element passes through pores of a fiber sheet (gaps between fibers). The dispersed oil in the coolant is captured in the pores of the fiber sheet. By setting the size of the pores of the fiber sheet, dispersed oil with a desired size can be separated from the coolant. However, if the pores of the fiber sheet are too small, the pores of the fiber sheet can easily become clogged, although fine dispersed oil can be captured. If the pores of the fiber sheet are too large, separation of fine dispersed oil is difficult, although the clogging of the pores is reduced.

The present invention aims at separating dispersed oil in a coolant and reducing the clogging of a filter.

### Solution to Problem

The coolant supply apparatus of the present invention includes:
a coolant tank configured to store (i) a first coolant supplied to a machine tool and (ii) (a) machining debris and (b) dispersed oil dispersed from the first coolant, (a) the machining debris and (b) the dispersed oil flowing with the first coolant from a place supplied;
a debris separation section configured to separate the machining debris from a second coolant collected from a coolant stored in the coolant tank; and
a hydrophilic oil-repellent filter configured to separate the dispersed oil from a third coolant separation-treated in the debris separation section.

### Effects of Invention

In the coolant supply apparatus of the present invention, machining debris is separated from the coolant by the debris separation section before separation of dispersed oil. After that, dispersed oil is separated from the coolant, from which machining debris was separated, by the hydrophilic oil-repellent filter. Thus, the hydrophilic oil-repellent filter is less likely to be clogged with machining debris. The hydrophilic oil-repellent filter has oil repellency. Thus, the adhesion of dispersed oil to the filter is reduced, and the filter is less likely to be clogged with dispersed oil. Accordingly, according to the coolant supply apparatus described above, dispersed oil contained in the coolant can be separated, and the clogging of the filter can be reduced.

### BRIEF DESCRIPTION OF DRAWINGS

FIG. 1 is a schematic diagram of a coolant supply apparatus and a machine tool of this embodiment.

FIG. 2 is a diagram for explaining a hydrophilic oil-repellent filter in the coolant supply apparatus of this embodiment.

FIG. 3 is a schematic diagram of a coolant supply apparatus of Modification Example 1 of this embodiment.

FIG. 4 is a schematic diagram of a coolant supply apparatus of Modification Example 2 of this embodiment.

FIG. 5 is a diagram illustrating an example of the arrangement relationship between the coolant supply apparatus of this embodiment and machine tool of this embodiment.

### DESCRIPTION OF EMBODIMENTS

Hereinafter, one embodiment of the present invention is described with reference to the drawings.

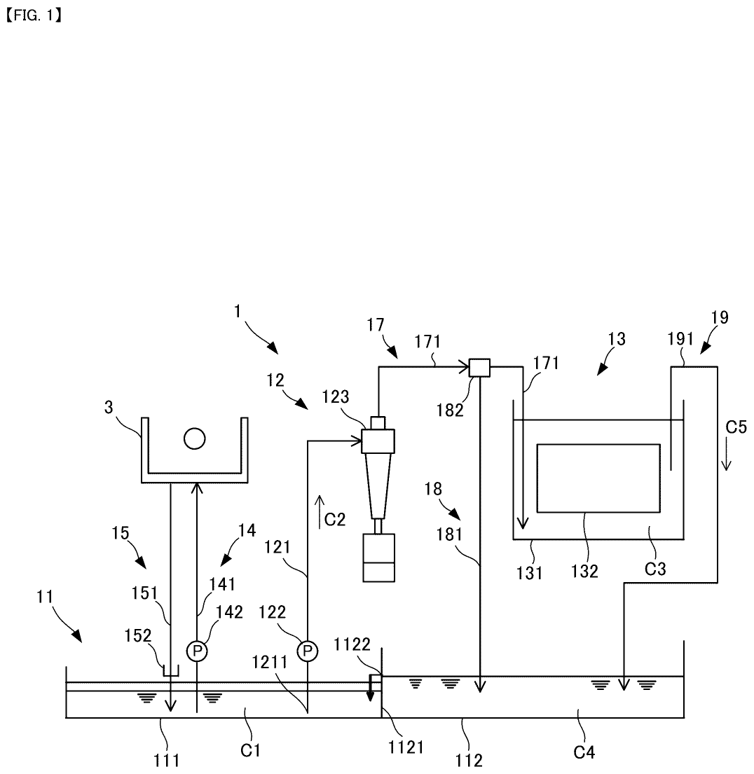

FIG. 1 is a schematic diagram of a coolant supply apparatus and a machine tool of this embodiment. The coolant supply apparatus 1 is attached to the machine tool 3. The coolant supply apparatus 1 supplies a liquid coolant to the machine tool 3. The coolant is not particularly limited. For the coolant, for example, known coolants used for machine tools are applicable. The coolant is, for example, a water-based coolant. The machine tool 3 is not particularly limited. The machine tool 3 performs cooling of workpieces and tools and other treatments using the coolant supplied from the coolant supply apparatus 1.

The coolant supply apparatus 1 is provided with a coolant tank 11, a debris separation section 12, and a dispersed oil separation section 13. A flow of coolant purification treatment in the coolant supply apparatus 1 is outlined as follows. A first coolant C1 stored in the coolant tank 11 is supplied to the machine tool 3. The first coolant C1 supplied to the machine tool 3 is returned to the coolant tank 11. The first coolant C1 stored in the coolant tank 11 is first supplied to the debris separation section 12, and then supplied to the dispersed oil separation section 13. The coolant supplied to the dispersed oil separation section 13 returns to the coolant tank 11. Each component will be described in detail below.

The coolant tank 11 includes a primary tank 111 and a secondary tank 112. The primary tank 111 stores the first coolant C1 that is to be supplied to the machine tool 3. The shape of the primary tank 111 is not particularly limited. The primary tank 111 is, for example, rectangular in plan view. To supply the first coolant C1 from the primary tank 111 to the machine tool 3, the coolant supply apparatus 1 has a supply section 14. The supply section 14 includes a supply tube 141 and a supply pump 142. The supply tube 141 includes a first end that is immersed in the first coolant C1 in the primary tank 111. The first end is disposed so as to be located below the liquid surface of the first coolant C1. The supply tube 141 includes a second end that is connected to the machine tool 3. The connection destination of the second end is not particularly limited. The second end is connected, for example, to a part to be washed in the machine tool 3. The part to be washed is, for example, an oil pan or the like. The supply pump 142 is disposed such that the flow of the coolant in the supply tube 141 can be adjusted. By this configuration, the supply section 14 supplies the first coolant C1 stored in the primary tank 111 to the machine tool 3.

The primary tank 111 stores the first coolant C1 used in the machine tool 3. To return the first coolant C1 from the machine tool 3 to the primary tank 111, the coolant supply apparatus 1 includes a return section 15. The return section 15 includes a return tube 151. The return tube 151 includes a first end that is connected to the machine tool 3. The connection destination of the first end is not particularly limited. The first end is, for example, connected to a coolant collection section of the machine tool 3. The return tube 151 includes a second end that discharges the first coolant C1 to be returned into the primary tank 111. The second end may be disposed so as to be located above the liquid surface of the first coolant C1 in the primary tank 111 or may be disposed so as to be immersed in the first coolant C1. By this configuration, the return section 15 returns the first coolant C1 from the machine tool 3 to the primary tank 111. A filter 152 may be disposed on the second end of the return tube 151. The filter 152 separates, for example, large machining debris and the like.

By the supply section 14 and the return section 15, the first coolant C1 circulates between the primary tank 111 and the machine tool 3. In the machine tool 3, machining debris are generated by machining, such as cutting or grinding. In the machine tool 3, a lubricant, a cutting oil, and the like are used. Therefore, machining debris and dispersed oil flow through the return section 15, along with the first coolant C1 supplied to the machine tool 3. The first coolant C1 stored in the primary tank 111 contains machining debris and dispersed oil dispersed in liquid.

The secondary tank 112 is disposed so as to be adjacent to the primary tank 111. The shape of the secondary tank 112 is not particularly limited. The secondary tank 112 is, for example, rectangular in plan view. The secondary tank 112 includes a side wall 1121 disposed on the primary tank 111 side. The side wall 1121 has an opening 1122. The secondary tank 112 is configured such that a fourth coolant C4 in the secondary tank 112 flows in the primary tank 111 through the opening 1122.

The debris separation section 12 separates machining debris from the coolant (referred to as a second coolant C2) collected from the coolant tank 11. The debris separation section 12 includes a pipe 121, a pump 122, and a centrifugal filter 123. The pipe 121 includes a collection port 1211 that collects the first coolant C1 stored in the primary tank 111. The collection port 1211 is located below the liquid surface of the first coolant C1 stored in the primary tank 111. In the pipe 121, an end different from the collection port 1211 is connected to the centrifugal filter 123. The pump 122 is disposed so as to adjust the flow of the second coolant C2 in the pipe 121. The second coolant C2 suctioned by the pump 122 and the pipe 121 contains machining debris and dispersed oil. This second coolant C2 is supplied to the centrifugal filter 123. The centrifugal filter 123 separates machining debris from the second coolant C2 using a centrifugal force. The centrifugal filter 123 creates a swirling flow in the supplied second coolant C2 using a propeller. The centrifugal filter 123 gathers machining debris at the bottom of the filter. The centrifugal filter 123 discharges the coolant (referred to as a third coolant C3), from which machining debris was separated, from the upper part thereof.

Part of the third coolant C3, from which machining debris is separated by the debris separation section 12, is transferred to the dispersed oil separation section 13 by a second transfer section 17. The second transfer section 17 includes a second transfer tube 171 that transfers the coolant. The second transfer tube 171 includes a first end that is connected to a coolant discharge outlet of the debris separation section 12. The second transfer tube 171 includes a second end that discharges the third coolant C3 into the dispersed oil separation section 13. The second transfer section 17 may include a pump that controls the flow of the third coolant C3 in the tube.

The rest of the third coolant C3, from which machining debris is separated by the debris separation section 12, is transferred to the secondary tank 112 by a third transfer section 18. The third transfer section 18 includes a third transfer tube 181 that transfers the coolant. The third transfer tube 181 includes a first end that is connected to the middle of the second transfer tube 171. At the connection part of the third transfer tube 181 and the second transfer tube 171, a throttle valve 182 is disposed. The throttle valve 182 adjusts the amount of the coolant flowing from the debris separation section 12 to the third transfer tube 181 and the amount of the coolant flowing from the debris separation section 12 to the second transfer tube 171. The third transfer tube 181 includes a second end that discharges the third coolant C3 into the secondary tank 112. The third transfer section 18 may include a pump that controls the flow of the third coolant C3 in the tube.

The dispersed oil separation section 13 includes an oil separation tank 131 and a hydrophilic oil-repellent filter 132. The oil separation tank 131 stores the third coolant C3 supplied from the debris separation section 12. The oil separation tank 131 stores the third coolant C3, from which machining debris was separated. The oil separation tank 131 stores the third coolant C3 that contains dispersed oil. The shape of the oil separation tank 131 is not particularly limited. The oil separation tank 131 is, for example, rectangular in plan view. The hydrophilic oil-repellent filter 132 is disposed in the oil separation tank 131. The hydrophilic oil-repellent filter 132 separates dispersed oil from the third coolant C3, from which machining debris was separated by the debris separation section 12. The hydrophilic oil-repellent filter 132 has both hydrophilicity and oil repellency.

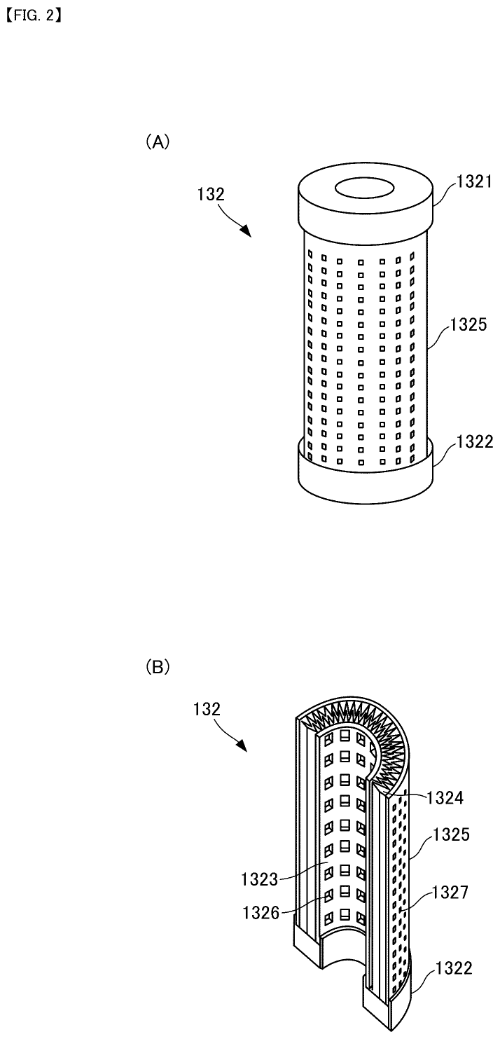

FIG. 2(A) is an external view of the hydrophilic oil-repellent filter in the coolant supply apparatus of this embodiment, and FIG. 2(B) is a sectional view of the hydrophilic oil-repellent filter. The hydrophilic oil-repellent filter 132 includes a first end plate 1321, a second end plate 1322, an outer tube 1325, a hydrophilic oil-repellent filter media 1324, and an inner tube 1323.

The first end plate 1321 has a hollow cylindrical shape. The second end plate 1322 has a similar shape to that of the first end plate 1321. The first end plate 1321 and the second end plate 1322 sandwich and secure the inner tube 1323, the hydrophilic oil-repellent filter media 1324, and the outer tube 1325.

The inner tube 1323 has a hollow cylindrical shape. The inner tube 1323 is disposed so as to be substantially coaxial with the first end plate 1321 and the second end plate. The inner tube 1323 includes at least one through hole 1326 that penetrates the inner tube 1323 in the radial direction. The at least one through hole 1326 opens at the inner and outer surfaces of the inner tube 1323. The size of the at least one through hole 1326 is not particularly limited. The size of the at least one through hole 1326 is larger than the average size of dispersed oil. The material of the inner tube 1323 is not particularly limited. Preferably, the inner tube 1323 is composed of an oil-repellent material.

The hydrophilic oil-repellent filter media 1324 is disposed on the outside of the inner tube 1323. The hydrophilic oil-repellent filter media 1324 is disposed so as to surround the inner tube 1323 all the way around. However, the hydrophilic oil-repellent filter media 1324 may be disposed so as to surround at least a part of the outer surface of the inner tube 1323. The hydrophilic oil-repellent filter media 1324 has a bellows shape in axial view. The hydrophilic oil-repellent filter media 1324 has a mesh structure so as to allow the coolant and dispersed oil to pass through. The hydrophilic oil-repellent filter media 1324 has a plurality of meshes so as to allow the coolant to pass through. The size of the meshes is smaller than the average size of dispersed oil. However, the size of the meshes may be larger than the average size of dispersed oil. The size of the meshes may be any size that does not substantially allow dispersed oil to pass through. The hydrophilic oil-repellent filter media 1324 is composed of an oil-repellent material. The oil-repellent material is not particularly limited as long as it has oil repellency. The oil-repellent material is, for example, oil-repellent polypropylene.

The outer tube 1325 has a hollow cylindrical shape. The outer tube 1325 is disposed so as to be substantially coaxial with the first end plate 1321 and the second end plate. The outer tube 1325 includes at least one through hole 1327 that penetrates the outer tube 1325 in the radial direction. The at least one through hole 1327 opens at the inner surface and outer surface of the outer tube 1325. The size of the at least one through hole 1327 is not particularly limited. The size of the at least one through hole 1327 is larger than the average size of dispersed oil. Preferably, the size of the at least one through hole 1327 is smaller than that of the through hole 1326 of the inner tube 1323. The material of the outer tube 1325 is not particularly limited. Preferably, the outer tube 1325 is composed of an oil-repellent material.

The hydrophilic oil-repellent filter 132 having such a configuration is disposed in the oil separation tank 131. When the third coolant C3 is supplied from the debris separation section 12 to the oil separation tank 131, the third coolant C3 flows into the hydrophilic oil-repellent filter 132 through the through hole 1327 of the outer tube 1325. The coolant that has passed through the outer tube 1325 reaches the hydrophilic oil-repellent filter media 1324. The hydrophilic oil-repellent filter media 1324 repels dispersed oil and allows the coolant (referred to as a fifth coolant C5) that does not contain dispersed oil to pass through. The dispersed oil repelled by the hydrophilic oil-repellent filter media 1324 passes through the outer tube 1325 and flows out of the hydrophilic oil-repellent filter 132. The dispersed oil that has flowed out of the hydrophilic oil-repellent filter 132 combines with other dispersed oil drops and floats to the liquid surface of the oil separation tank 131. Meanwhile, the coolant that has passed through the hydrophilic oil-repellent filter media 1324 passes through the through hole 1326 of the inner tube 1323 and reaches the hollow part of the hydrophilic oil-repellent filter 132. As such, by collecting the fifth coolant C5 that has passed through the hydrophilic oil-repellent filter 132, a coolant, from which machining debris and dispersed oil have been separated, can be obtained.

Referring to FIG. 1, the fifth coolant C5, from which dispersed oil was separated by the hydrophilic oil-repellent filter 132, is transferred to the secondary tank 112 by a fourth transfer section 19. The fourth transfer section 19 includes a fourth transfer tube 191 that transfers the fifth coolant C5. The fourth transfer tube 191 includes a first end that is connected to the oil separation tank 131. The first end is disposed so as to collect the fifth coolant C5 that has passed through the hydrophilic oil-repellent filter 132. The fourth transfer tube 191 includes a second end that discharges the fifth coolant C5 into the secondary tank 112. The fourth transfer section 19 may include a pump that controls the flow of the fifth coolant C5 in the tube.

As described above, in the coolant supply apparatus 1, machining debris is separated from the coolant by the debris separation section 12 before separation of dispersed oil. After that, dispersed oil is separated from the coolant, from which machining debris has been separated, by the dispersed oil separation section 13. Thus, the hydrophilic oil-repellent filter 132 in the dispersed oil separation section 13 is less likely to be clogged with machining debris. The hydrophilic oil-repellent filter 132 has oil repellency. Thus, the adhesion of dispersed oil to the hydrophilic oil-repellent filter 132 is reduced, and the hydrophilic oil-repellent filter 132 is less likely to be clogged with dispersed oil. Accordingly, according to the coolant supply apparatus 1, dispersed oil contained in the coolant can be separated, and the clogging of the filter can be reduced.

### Modification Example 1

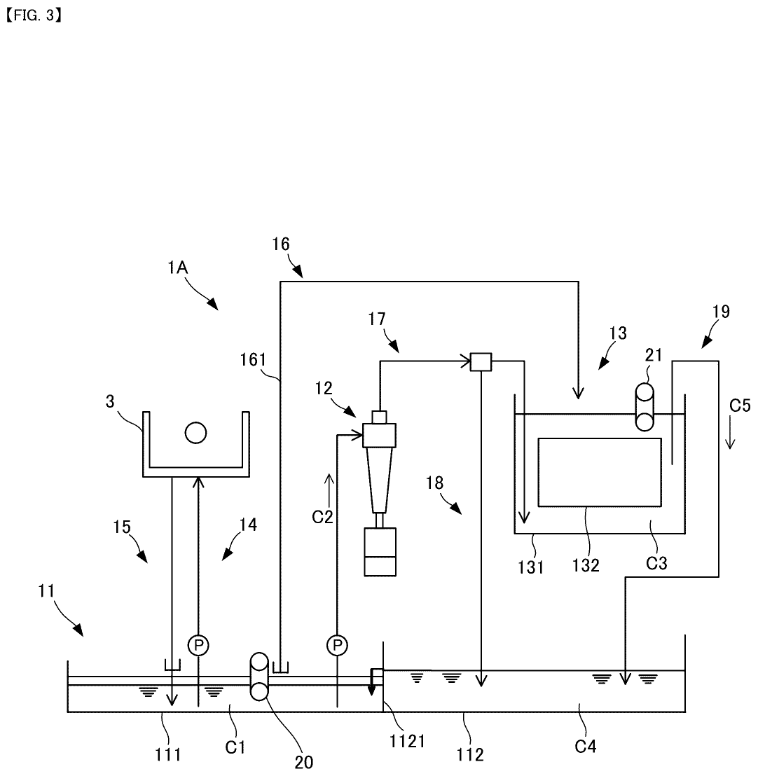

FIG. 3 is a schematic diagram of a coolant supply apparatus of Modification Example 1 of this embodiment. This coolant supply apparatus 1A has a structure in which a mechanism for collecting floating oil is added to the coolant supply apparatus 1 described above. In the coolant supply apparatus 1A, the configurations other than the configuration for collecting floating oil are the same as those of the coolant supply apparatus 1.

In the coolant supply apparatus 1A, the primary tank 111 stores floating oil floating on the liquid surface of the first coolant C1, in addition to machining debris and dispersed oil. The coolant supply apparatus 1A is provided with a floating oil separation section 20 that separates floating oil from the first coolant C1 stored in the primary tank 111.

The floating oil separation section 20 collects floating oil floating on the liquid surface of the first coolant C1 stored in the primary tank 111. The floating oil separation section 20 is, for example, a belt, screw, disk, or suction oil skimmer or the like. A belt oil skimmer includes a rotating belt, a part of which is immersed in the first coolant C1. The belt oil skimmer collects floating oil from the primary tank 111 by causing the floating oil to adhere to the rotating belt. A screw oil skimmer includes a screw, a part of which is immersed in the first coolant C1. The screw oil skimmer collects floating oil by rotating the screw. A disk oil skimmer includes a rotating disk, a part of which is immersed in the first coolant C1. The disk oil skimmer collects floating oil from the primary tank 111 by causing the floating oil to adhere to the rotating disk. A suction oil skimmer includes a suction nozzle that is disposed so as to be in contact with floating oil. The suction oil skimmer collects floating oil by suctioning the floating oil with the suction nozzle. However, the floating oil separation section 20 is not limited to a belt, screw, disk, or suction oil skimmer, and may be any mechanism that can collect floating oil.

The floating oil collected by the floating oil separation section 20 is transferred to the dispersed oil separation section 13 by a first transfer section 16. The first transfer section 16 includes a transfer path 161 that transfers the floating oil. The transfer path 161 is not particularly limited as long as it can transfer the floating oil. The transfer path 161 is, for example, a belt conveyor, a pipe, or the like. The transfer path includes a first end that receives the floating oil collected by the floating oil separation section 20. The transfer path 161 includes a second end that discharges the floating oil into the oil separation tank 131 in the dispersed oil separation section 13. The second end is disposed above the liquid surface of the third coolant C3 stored in the oil separation tank 131. However, the second end may be disposed below the liquid surface of the third coolant C3 stored in the oil separation tank 131.

The coolant supply apparatus 1A further includes a waste oil collection mechanism 21 that collects the floating oil that has been transferred to the dispersed oil separation section 13 by the first transfer section 16. The waste oil collection mechanism 21 is not particularly limited. The waste oil collection mechanism 21 is, for example, a belt, screw, disk, or suction oil skimmer as described above or the like.

As such, in the coolant supply apparatus 1A according to Modification Example 1, floating oil stored in the primary tank 111 is collected. Thus, the floating oil separation section 20 and the debris separation section 12 and dispersed oil separation section 13 described above separate not only machining debris and dispersed oil but also floating oil. Accordingly, the coolant supply apparatus 1A further improves the coolant purification performance.

Furthermore, in the coolant supply apparatus 1A, the floating oil separation section 20 separates floating oil in the primary tank 111. Thus, floating oil is less likely to be mixed in the coolant supplied from the primary tank 111 to the debris separation section 12 and the dispersed oil separation section 13. Accordingly, the coolant supply apparatus 1A can reduce the load on the oil separation function of the debris separation section 12 and dispersed oil separation section 13 and extend the lives of the debris separation section 12 and dispersed oil separation section 13.

For example, when the operation of the machine tool is suspended for some period of time, the first coolant C1 stored in the primary tank 111 does not circulate between the primary tank 111 and the machine tool 3. Therefore, the primary tank 111 is in a static state, and the flow of the first coolant C1 is less likely to occur in the primary tank 111. In this case, floating oil is likely to occur in the primary tank 111. Thus, when the static state of the primary tank 111 continues, the floating oil accelerates the degradation of the first coolant C1. In contrast, the coolant supply apparatus 1A can separate floating oil from the primary tank 111 by the floating oil separation section 20 even if the first coolant C1 is not circulating. Accordingly, the coolant supply apparatus 1A can purify the coolant regardless of whether the machine tool is operating or not.

Furthermore, in the coolant supply apparatus 1A, the first transfer section 16 transfers floating oil in the primary tank 111 to the dispersed oil separation section 13. The floating oil transferred to the dispersed oil separation section 13 floats to the liquid surface of the third coolant C3 stored in the oil separation tank 131. Here, in the dispersed oil separation section 13, the dispersed oil repelled by the hydrophilic oil-repellent filter 132 is agglomerated. As a result, coarsened dispersed oil floats to the liquid surface of the third coolant C3 stored in the oil separation tank 131. That is, not only floating oil but also coarsened dispersed oil float on the liquid surface of the third coolant C3 in the oil separation tank 131. When the waste oil collection mechanism 21 collects the oil floating on the liquid surface of the third coolant C3 in the oil separation tank 131, both floating oil and dispersed oil are collected together. Thus, it is not necessary to dispose waste oil collection mechanisms that collect floating oil and dispersed oil, respectively. Accordingly, the coolant supply apparatus 1A can collect floating oil and dispersed oil efficiently and can make the structure of the coolant supply apparatus compact.

In the coolant supply apparatus 1A according to Modification Example 1, the configuration that transfers floating oil in the primary tank 111 to the dispersed oil separation section 13 to collect the floating oil. However, the floating oil in the primary tank 111 may be collected in the primary tank 111. That is, the coolant supply apparatus 1A may not include the first transfer section 16.

### Modification Example 2

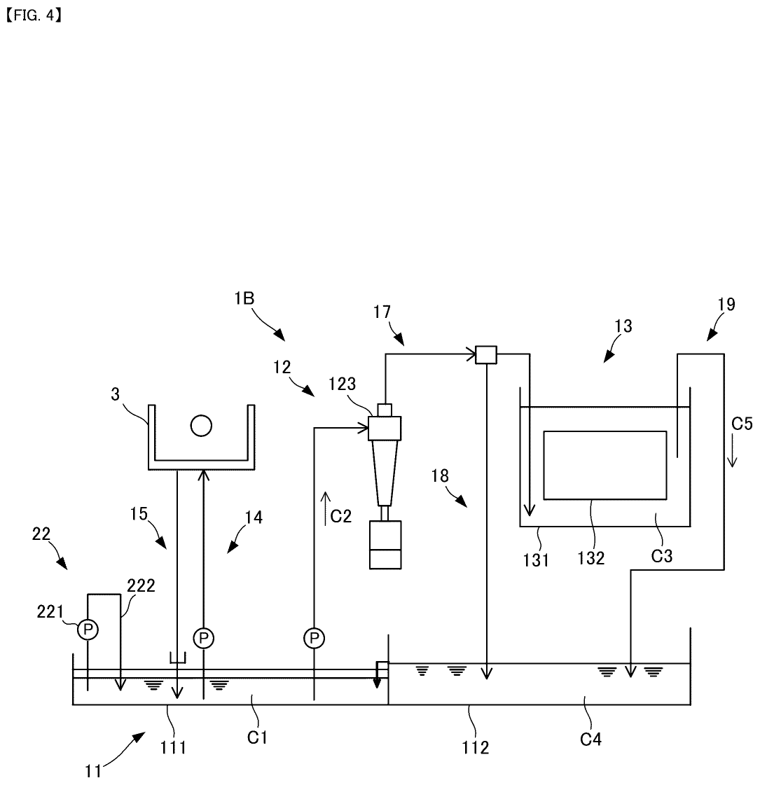

FIG. 4 is a schematic diagram of a coolant supply apparatus of Modification Example 2 of this embodiment. This coolant supply apparatus 1B has a structure in which a stirring section that stirs the first coolant C1 in the primary tank 111 is added to the coolant supply apparatus 1 described above. In the coolant supply apparatus 1B, the configurations other than the stirring section are the same as those of the coolant supply apparatus 1.

The coolant supply apparatus 1B further includes the stirring section 22 that stirs the first coolant C1 stored in the primary tank 111. The stirring section 22 includes a stirring pump 221 and a pipe 222. Both ends of the pipe 222 are immersed in the first coolant C1 in the primary tank 111. By the stirring pump 221, the coolant flowing into one end of the pipe 222 is discharged from the other end. Thereby, the first coolant C1 in the primary tank 111 is stirred. However, the configuration of the stirring section 22 is not limited thereto. The stirring section 22 may have any configuration that can generate a flow of the first coolant C1 in the primary tank 111.

In the primary tank 111, machining debris are likely to settle down on the bottom of the tank. As the first coolant C1 in the primary tank 111 is stirred by the stirring section 22, the settled machining debris are easily stirred up into the liquid of the first coolant C1. Accordingly, the coolant supply apparatus 1B collects machining debris with a high collection efficiency.

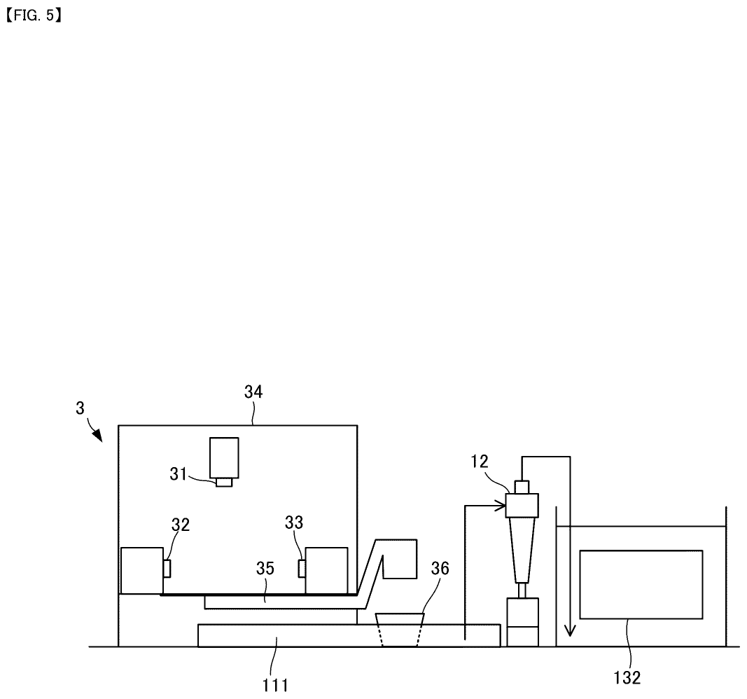

FIG. 5 is a diagram illustrating an example of the arrangement relationship between the coolant supply apparatus and machine tool of this embodiment. The coolant supply apparatuses 1, 1A, and 1B are disposed so that at least a part thereof is housed below the machine tool 3. More specifically, the machine tool 3 includes a tool spindle 31 that holds tools and workpiece spindles 32 and 33 that hold workpieces. The machine tool 3 includes a machining chamber 34 where the workpieces are machined with the tool spindle 31 and the workpiece spindles 32 and 33. The machining chamber 34 is a space formed by splash guards or the like. The coolant supplied to the machine tool 3 is, for example, sprayed into the machining chamber 34. The coolant sprayed into the machining chamber 34 is collected by a chip conveyor 35, along with machining debris. The chip conveyor 35 transports the machining debris outside the machine tool 3. The machining debris transported outside the machine tool 3 are received by a bucket 36. Under the chip conveyor 35, the primary tank 111 is installed. The chip conveyor 35 is configured so that the collected coolant is discharged downward. The primary tank 111 is disposed so as to receive the coolant discharged from the chip conveyor 35.

The above is an explanation of the embodiment of the present invention. The explanation of the embodiment above is illustrative in all respects and not restrictive. A person skilled in the art would be able to make variations and modifications as appropriate. The scope of the present invention is shown not by the embodiment described above, but by the claims. Furthermore, the scope of the present invention encompasses modifications made from the embodiment within a scope equivalent to the scope of the claims.

For example, in the coolant supply apparatuses 1, 1A, and 1B described above, the coolant tank 11 includes the primary tank 111 and the secondary tank 112. However, the coolant tank 11 may not include the secondary tank 112. The coolant flowing from the debris separation section 12 and the dispersed oil separation section 13 into the secondary tank 112 may flow into the primary tank 111.

In the coolant supply apparatuses 1, 1A, and 1B described above, the hydrophilic oil-repellent filter 132 has a hollow cylindrical shape as a whole. However, the shape of the hydrophilic oil-repellent filter 132 is not limited thereto. Furthermore, in the hydrophilic oil-repellent filter 132, the coolant to be filtered may pass through the filter from the outside toward the inside or may pass through the filter from the inside toward the outside. In short, the hydrophilic oil-repellent filter 132 may have any configuration that can separate dispersed oil from the coolant.

In the coolant supply apparatuses 1, 1A, and 1B described above, the debris separation section 12 separates machining debris. This does not mean that the debris separation section 12 separates all machining debris contained in the coolant without fail. The debris separation section 12 may separate all machining debris contained in the coolant or may separate part of machining debris contained in the coolant. The same is true for the dispersed oil separation section 13 and the floating oil separation section 20.

In the coolant supply apparatuses 1, 1A, and 1B described above, the dispersed oil separation section 13 includes the hydrophilic oil-repellent filter 132. However, the dispersed oil separation section 13 may include other filters in addition to the hydrophilic oil-repellent filter 132. Examples of the other filters include a lipophilic filter, a bubble-type oil separator. A lipophilic filter is composed of a lipophilic fiber. The lipophilic filter captures and separates dispersed oil by adsorbing the dispersed oil. The lipophilic filter is, for example, a nonwoven fabric or the like. A bubble-type oil separator generates bubbles. The bubble-type oil separator separates the dispersed oil by causing the dispersed oil to be adsorbed on the generated bubbles.

In the coolant supply apparatuses 1, 1A, and 1B described above, the first coolant C1 stored in the primary tank 111 is supplied to the machine tool 3. However, the coolant to be supplied to the machine tool 3 may be a coolant stored in an area other than the primary tank 111. For example, the fourth coolant C4 stored in the secondary tank 112 may be supplied to the machine tool 3. The third coolant C3 stored in the oil separation tank 131 may be supplied to the machine tool 3. The fifth coolant C5, from which dispersed oil has been removed by the hydrophilic oil-repellent filter 132, may be supplied to the machine tool 3.

In the above description, the floating oil and the dispersed oil are those that exist as oil drops. The floating oil and the dispersed oil are different from an oil content emulsified in the coolant.

### REFERENCE SIGNS LIST

1, 1A, 1B Coolant supply apparatus
11 Coolant tank
111 Primary tank
112 Secondary tank
12 Debris separation section
121 Pipe
1211 Collection port
122 Pump
123 Centrifugal filter
13 Dispersed oil separation section
131 Oil separation tank
132 Hydrophilic oil-repellent filter
1321 First end plate
1322 Second end plate
1323 Inner tube
1324 Hydrophilic oil-repellent filter media
1325 Outer tube
1326, 1327 Through hole
14 Supply section
15 Return section
16 First transfer section
161 Transfer path
17 Second transfer section
171 Second transfer tube
18 Third transfer section
181 Third transfer tube
182 Throttle valve
19 Fourth transfer section
191 Fourth transfer tube
20 Floating oil separation section
21 Waste oil collection mechanism
22 Stirring section
221 Stirring pump
222 Pipe
C1 to C5 Coolant
3 Machine tool

1. A coolant supply apparatus comprising:
a coolant tank configured to store (i) a first coolant supplied to a machine tool and (ii) (a) machining debris, (b) dispersed oil dispersed in the first coolant, and (c) floating oil floating on a liquid surface of the first coolant, (a) the machining debris, (b) the dispersed oil, and (c) floating oil flowing with the first coolant from a place supplied;
a debris separation section configured to separate the machining debris from a second coolant collected from a coolant stored in the coolant tank;
a hydrophilic oil-repellent filter configured to separate the dispersed oil from a third coolant separation-treated in the debris separation section;
a floating oil separation section configured to separate the floating oil from the first coolant stored in the coolant tank; and
a first transfer section configured to transfer the floating oil separated from the first coolant by the floating oil separation section to an oil separation tank provided with the hydrophilic oil-repellent filter.

2. (canceled)

3. (canceled)

4. The coolant supply apparatus according to claim 1, wherein
the debris separation section includes a collection port configured to collect the first coolant stored in the coolant tank, and
the collection port is located below the liquid surface of the first coolant stored in the coolant tank.

5. The coolant supply apparatus according to claim 1, further comprising:
a fourth transfer section configured to transfer a coolant, from which the dispersed oil has been separated by the hydrophilic oil-repellent filter, to the coolant tank.
